(19) United States
(12) Patent Application Publication
(10) Pub. No.: US 2007/0192109 A1
(43) Pub. Date: Aug. 16, 2007

(54) VOICE COMMAND INTERFACE DEVICE

(75) Inventors: Douglas B. Likens, San Carlos, CA (US); Richard M. Carlson, Saratoga, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: IVC Inc., Milpitas, CA (US)

(21) Appl. No.: 11/560,256

(22) Filed: Nov. 15, 2006

Related U.S. Application Data
(60) Provisional application No. 60/766,841, filed on Feb. 14, 2006.

(51) Int. Cl. G10L 21/00

(52) U.S. Cl. 704/275

(57) ABSTRACT

A device includes a speech input device. A speech recognition processor connected to the speech input device receives speech input. The device includes a computer readable medium coupled to the speech recognition processor. A command table stored on the computer readable medium includes commands corresponding to a control on a manual input interface on a digital music player. The digital music player is separate from the speech input device. The speech recognition processor compares the speech input to the commands in the command table and generates instructions if the speech input matches a command in the command table. A programmable controller is coupled to the speech recognition processor and is configured to receive instructions and to convert the instructions into control signals. The device includes a standard interface connector coupled to the programmable controller. The programmable controller sends the control signals through the standard interface connector.

This application claims priority to U.S. Provisional Application Ser. No. 60/766,841 filed on Feb. 14, 2006.

### BACKGROUND

1. Field of the Invention

The present invention relates generally to devices for controlling digital music players and, in particular, to a voice command interface device.

2. Relevant technology

Digital music players have become more and more popular in recent years. Music and other files are typically stored in the memory of the digital music players. Users can selectively play back the music as desired. Digital music players frequently include a manual input interface that allows users to control which music files are played, such as selecting the music from a menu, fast-forward or skipping music files, and the like. The manual input interface also allows user to control how the music files are played, such as allowing the user to control playback options, playback volume, and the like.

Digital music players are often portable. The portability of digital music players allow users to use the players in a variety of situations, such as while driving, exercising, while at home, or in other situations. Frequently, the manual nature of the input interfaces requires the user to pay somewhat close attention to the input interface to locate the desired control and then select the correct button or other manual input on the manual user input interface.

For example, while driving, the user frequently must divert attention from the road to select a song. Similarly, while exercising, a user often must stop exercising to change which music file is played or how the music file is played. Further still, while at home digital music players are often connected to home stereos. In such circumstances, the user must go to the portable music player to change how the device is controlled. In any case, the user frequently must divert attention from an activity to interact with the manual input interface on the portable music player.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

A voice command interface device is provided that includes a speech input device. A speech recognition processor connected to the speech input device receives speech input. The voice command interface device includes a computer readable medium coupled to the speech recognition processor. The computer readable medium may be separate from the speech recognition processor, such as a flash memory unit, or may be integral to the speech recognition processor. A command table stored on the computer readable medium includes commands corresponding to one or more control on a manual input interface on a digital music player. The digital music player is separate from the speech input device.

The speech recognition processor compares the speech input to the commands in the command table and generates instructions if the speech input matches a command in the command table. A programmable controller is coupled to the speech recognition processor and is configured to receive instructions and to convert the instructions into control signals. The device includes a standard interface connector coupled to the programmable controller. The programmable controller sends the control signals through the standard interface connector.

In one example, the speech input device is an external microphone. In addition, the command table may include instructions in more than one human language. Further, the command table may be updated as desired, such as by changing the human language or languages. Additionally, in one example the speech input device is the only way that a user is able to control the device while the standard interface connector is the only way for the device to control a digital music player.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a digital music player according to one example of the present invention; and

FIG. 2 illustrates a schematic of a voice command interface device according to one example of the present invention.

### DETAILED DESCRIPTION

A voice command interface device is provided in this disclosure. The voice command interface device provides voice control for portable digital music players. The voice command interface device is configured to receive speech input from a user and convert the speech input into electrical audio signals. In one example, a microphone, such as an external microphone, internal microphone, wireless microphone, and the like, is used to receive and convert the speed input.

The device has command data corresponding to one or more commands stored thereon. The device compares the electrical audio signals to the command data to determine whether a voice command has been received. If a voice command has been received, the device sends a control signal to a digital music player. The device is separate and distinct from the digital music player. The device includes a standard interface connector that allows the device to interface with a digital music player. In one example, the connector allows the device to plug directly into a corresponding digital music player.

The voice command interface device according to one example includes command data corresponding to any number of human languages. The voice command interface may also be programmed at a later time to update or alter command data for additional languages as desired. As used herein, a voice command interface device shall be understood to mean a device that provides control of a digital music player using speech recognition. The control provided by the voice command interface device includes at least some of the control provided by an input device or manual input device of the digital music player. As used herein, a digital music player shall be understood to mean a device capable of playing back digital media files, including digital music files, digital video files, and the like. Digital media files shall also be understood to specifically apply to digital music files, such as files in MP3, WMA, Realaudio, AAC format, or similar digital music formats. A digital music player shall be understood to specifically exclude devices capable of communication over wireless networks, such as cellular telephone networks and the Internet. In addition, as used herein, standard interface connector will be understood to mean interface connectors typical to digital music players. Interface connector will further specifically be understood to include at least those interface connectors associated with Universal Serial Bus connections and the connections typical of iPod devices sold and/or marketed by Apple Computers.

In the following description for purposes of explanation, numerous specific details are set forth to provide a thorough understanding of the present device. It will be apparent, however, to one skilled in the art that the present method and apparatus may be practice without these specific details. Reference in the specification to “embodiment” or “example” mean that a particular features, structure, or characteristic described in connection with the embodiment is included in at least one embodiment or example. The appearance of the phrase “in one embodiment” in various places in the specification are not necessarily all referring to the same embodiment. Throughout the drawings, identical reference numbers designate similar, but not necessarily identical, elements.

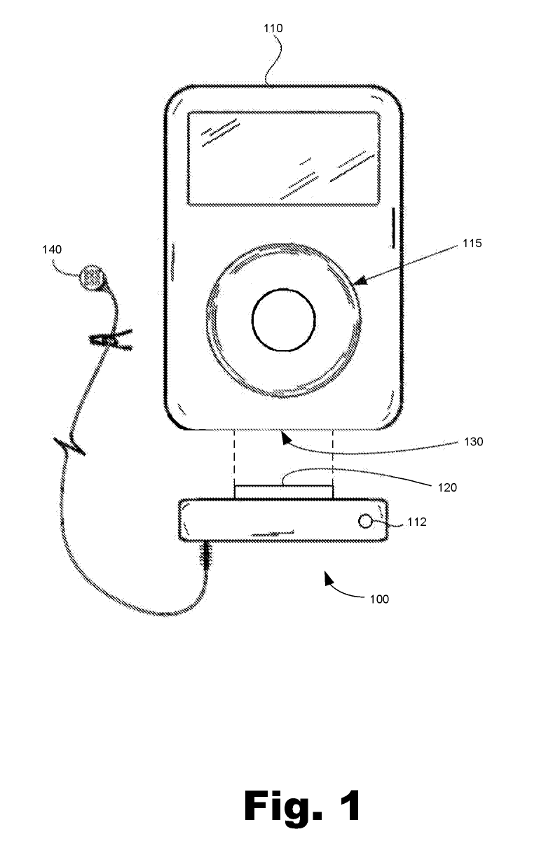

FIG. 1 is a schematic diagram of a voice command interface device 100 that is suited for use with a portable digital music player 10. As illustrated in FIG. 1, the voice command interface device 100 is provided separately from the portable music player 110. The portable digital music player 110 includes a manual input interface 115. The manual input interface 115 allows a user to control the digital music player 110. Controlling the digital music player 110 may include controlling which music files are played as well as how the music files are played.

The voice command interface device 100 includes a standard interface connector 120. The standard interface connector 120 is configured to be connected to a corresponding player interface connector 130, which is part of the digital music player 110. As such, the device 100 may be plugged into the digital music player 110 by plugging the standard interface connector 120 into the player standard interface connector 130. In the present example, the standard interface connector 120 is the only interface between the digital music player 110 and the device 100.

After the device 100 is connected to the digital music player, turning the digital music player 10 ON also activates the device 100. The device 100 includes a speech input device, such as a microphone 140. The microphone 140 receives speech input from a user. The microphone 140 in the present example is the only source of speech input from a user.

The speech input received from the user is compared to a list of voice commands. The voice commands may be provided by the manufacturer or otherwise. If the speech input matches the voice commands, the device 100 provides a control signal to the digital music player 110. These controls cause the digital music player 110 to execute the command associated with the voice command. When speech input is received, an indicator 112 is activated to indicate that the device 100 is active and receiving the speech input. The indicator 112 may specifically include visible indications, such as light output. Further, the indicator 112 may specifically include a light emitting diode (LED) that is illuminated when the device 100 is receiving speech input. The indicator may also be an audio signal such as “beep” via a speaker located on the voice command module.

The voice commands may include commands that correspond to the commands provided with input interface 115. As a result, the device 110 may allow users to control the digital music player 110 using voice commands. Using voice commands may allow users to control the digital music player 110 without interrupting activities they are engaged in to focus on the manual input interface 115. One exemplary voice command interface device will be discussed in more detail below.

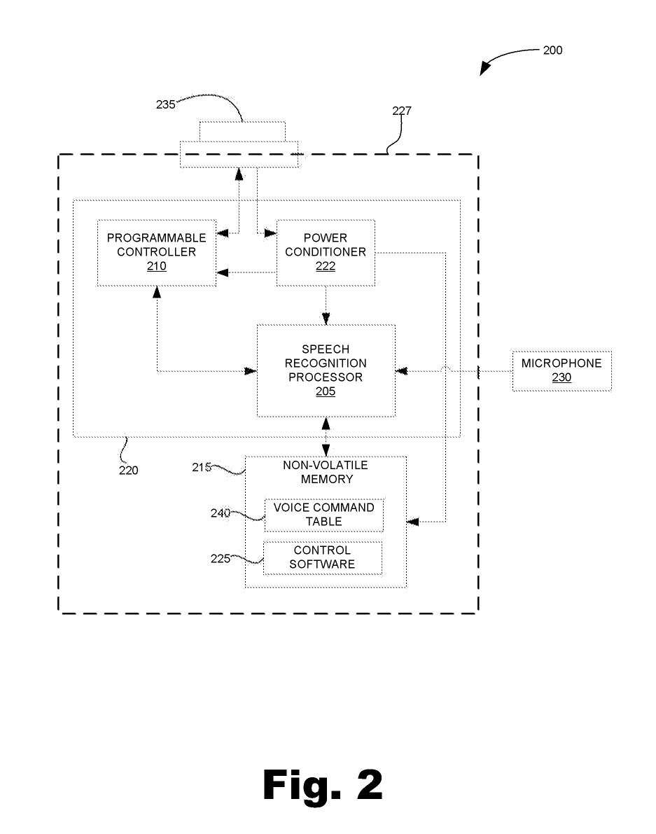

FIG. 2 is a schematic diagram of a voice command interface device 200 according to one example. The voice command interface device 200 includes several integrated circuits, including, without limitation, a speech recognition processor 205, a programmable controller 210, and non-volatile memory 215. According to one example, each of the integrated circuits is connected to a printed circuit board 220. While certain components are described on the circuit board 220, it is understood that any number of components may be included with or be integral to the circuit board 220.

The device 200 also includes a power conditioner 222. The power condition 222 receives power input from a power source (not shown) and conditions the power for use by the device's 200 components. According to one example, the power source is internal to the device 200, such as a battery. The power source may also be external to the device, such as an AC power source, a DC power source, or other power source. The power conditioner 222 may be configured to receive power from an external and/or internal power source.

The voice command interface device 200 further includes control software 225. The control software may be stored at any suitable location, such as in non-volatile memory 215. An enclosure 227 surrounds any number of these components.

A speech input device, such as an external microphone 230 is coupled to the speech recognition processor 205. A standard interface connector 235 is coupled to the programmable controller 210. As will be discussed in more detail below, the device 200 receives speech input through the microphone 230 which may be used to generate control signals. The device 200 then sends control signals for use by a digital audio player through the standard interface connector 235. The microphone may also be attached via a standard connector on the voice command module. This would allow replacement and exchange of the microphone with altering the voice command module.

More specifically, the microphone 230 detects the speech input including user voice commands and converts the speech input to electrical audio signals. The microphone 230 sends the resulting electrical audio signals to the speech recognition processor 205. The microphone 230 may be directly connected to the speech recognition processor 205 via a wire connection.

The speech recognition processor 205 processes the electrical audio signals using information stored in the non-volatile memory 215. In particular, the non-volatile memory 215 stores the proprietary control software and a voice command table 240. The voice command table 240 may include information for commands for a specific digital music player. For example, the voice command table 240 may include information related to commands that correspond to a given digital music players input interface. These commands may have names, such as pause, volume up, volume down, repeat, next song and/or other verbal commands. The voice command table 240 may specifically include information related to MP3 players, such as iPod devices.

Data corresponding to each of the desired commands is stored in the voice command table 240. Using the control software 225, the speech recognition processor 205 compares the electrical audio signals against the data stored in the voice command table 240. If the speech recognition processor 205 determines there is a match between the speech input and data on the voice command table 240, the speech recognition processor 205 generates unique instructions for each of the specific recognized voice commands. The unique instructions are sent to the programmable controller 210. The programmable controller 210 uses the instructions to generate control signals that are delivered to the portable digital music player 115, as shown in FIG. 1, via the standard interface connector 235. The digital music player 115 receives the control signals, which cause the digital music player 115 to execute the corresponding operation or process.

In one example, the standard interface connector 235 is designed to plug into a connector of a portable digital music player and make electrical contact with the circuitry within the portable digital music player. Each type of portable digital music player may use a unique connector. The use of a unique connector may provide a ready indication that the device 100 is configured for use with a given portable digital music player. To this point, the enclosure 227 has been discussed generally.

In one example, the enclosure 227 is sized such that the entire device 200 may be readily transported with the digital music player 115 illustrated in FIG. 1, which may also be readily portable. In another embodiment, the enclosure 227 encompasses additional components, such that the device may be built into accessories made for portable digital music players, like audio docking systems, alarm clocks, and similar applications for home or office use.

In another example, the enclosure 227 allows for the integration of the device 200 into automotive docking systems designed for portable digital music players. The home, office, and automotive docking applications may be arranged to come into contact with the portable digital music players through the bottom connector. The integration of the device 200 into such docking applications allows for voice command control of the portable digital music player. Unique versions of the device may be created for each type of portable digital music player, or their respective docking accessories, with each version being capable of replacing all controls on the input interface, such as buttons, that are associated with a corresponding voice command.

As previously introduced, users may speak a voice command, a list of which is provided by the manufacturer, into the microphone. Such a voice command replaces the act of physically pressing a button on the input interface of a portable digital music player. An example of a voice command is “play.” This command will cause the portable digital music player to play a music selection without the user having to press the play button. In this manner, the device allows the user to operate a portable digital music player in a hands-free mode, such as while walking, jogging, skiing, bike riding, etc. In automotive applications, the device enables operation of the portable digital music player in a hands-free mode, thereby increasing driver safety. In home or other stationary applications the device enables the user to operate the portable digital music player from a distance, allowing other tasks to be performed simultaneously. Several configuration of the device may be provided, with different configurations being suited for use with a portable digital music player, or docking accessory there is a specific list of voice commands to replace all button control functions.

In another example, the voice command interface device 200 may include several components integrated into a single chip. For example, the device 200 may include a speech recognition chip such as those manufactured by Sensory, Inc. and may include a chip from the RSC-4x IC family of chips. The chips, for example, may specifically include the chips commercially sold as the RSC-4128 and/or RSC-464 and subsequent versions of these IC's. The voice command module may use other voice control IC's not manufactured by Sensory. In any case, all devices according to the present disclosure use a microphone or other speech input device to receive speech input from a user and to convert the speech input into electrical audio signals. Additionally, all devices according to the present disclosure use a standard interface connector to allow the voice command interface device to connect the device to a digital music player. Further, all devices according to the present disclosure are provided separately from digital music players, such that the devices may be selectively coupled and decoupled to a digital music player as desired.

Embodiments herein may comprise a special purpose or general-purpose computer including various computer hardware, as discussed in greater detail below.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium.

Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A voice command interface device, comprising:
a speech input device;
a speech recognition processor connected to the speech input device to receive speech input;
a computer readable medium coupled to the speech recognition processor, the computer readable medium having a command table stored thereon containing one or more command corresponding to a control on a manual input interface on a digital music player, the digital music player being separate from the speech input device, wherein the speech recognition processor is configured to compare the speech input to the commands in the command table and to generate instructions if the speech input matches a command in the command table, the instructions corresponding to the command that is matched;
a programmable controller coupled to the speech recognition processor and being configured to receive instructions and to convert the instructions into control signals; and
a standard interface connector coupled to the programmable controller, the programmable controller being configured to send the control signals through the standard interface connector to a digital music player.

2. The device of claim 1, wherein the standard interface connector is adapted specifically for use with a portable digital music player.

3. The device of claim 1, wherein the command table residing on the computer readable medium includes commands in more than one human language.

4. The device of claim 1, further comprising an indicator configured to indicate when the device is receiving speech input.

5. The device of claim 4, wherein the indicator comprises a light.

6. The device of claim 5, wherein the light comprises a light emitting diode.

7. The device of claim 1, wherein the speech input device comprises an external microphone.

8. The device of claim 7, wherein the external microphone is directly connected to the speech input processor via a wire connection.

9. The device of claim 1, further comprising an enclosure surrounding the speech recognition processor, the computer readable medium, and the programmable processor.

10. The device of claim 7, further comprising a power source, the power source being located within the enclosure.

11. The device of claim 1, wherein the speech recognition processor, the computer readable medium, and the programmable processor are integrated onto a single chip.

12. The device of claim 1, wherein the device is configured to receive power from the digital music player.

13. A voice command interface device, comprising:
a speech input device;
means for processing speech input received from the speech input device;
a computer readable medium coupled to the means for processing speech input, the computer readable medium having a command table stored thereon containing one or more command corresponding to a control on a manual input interface on a digital music player, the commands include commands in more than one human language, the digital music player being separate from the speech input device, wherein the means for processing speech input is configured to compare the speech input to the commands in the command table and to generate instructions if the speech input matches a command in the command table, the instruction corresponding to the command that is matched;
a programmable controller coupled to the means for processing speech input and being configured to receive instructions and to convert the instructions into control signals; and
a standard interface connector coupled to the programmable controller, the programmable controller being configured to send the control signals through the standard interface connector to a digital music player.

14. The device of claim 13, wherein the commands stored on the computer readable medium may be selectively updated.

15. A voice command interface device, comprising:
a speech input device;
means for processing speech input received from the speech input device;
a computer readable medium coupled to the means for processing speech input, the computer readable medium having a command table stored thereon containing one or more command corresponding to a control on a manual input interface on a digital music player, the commands include commands in more than one human language, the digital music player being separate from the speech input device, wherein the means for processing speech input is configured to compare the speech input to the commands in the command table and to generate instructions if the speech input matches a command in the command table, the instruction corresponding to the command that is matched;
a programmable controller coupled to the means for processing speech input and being configured to receive instructions and to convert the instructions into control signals; and
a standard interface connector coupled to the programmable controller, the programmable controller being configured to send the control signals through the standard interface connector to a digital music player, wherein the speech input device is the only user input and the standard interface connector is the only output for control signals to a digital music player.
